(19) United States
(12) Patent Application Publication
(10) Pub. No.: US 2016/0069358 A1
(43) Pub. Date: Mar. 10, 2016

(54) HYDRAULIC MOTOR DRIVE DEVICE

(71) Applicant: Dingwen Du, Changsha (CN)

(72) Inventor: Dingwen Du, Changsha (CN)

(21) Appl. No.: 14/944,264

(22) Filed: Nov. 18, 2015

Related U.S. Application Data
(63) Continuation-in-part of application No. PCT/CN2013/076682, filed on Jun. 4, 2013.

(51) Int. Cl. F15B 11/16

(52) U.S. Cl. CPC F15B 11/16; F15B 2211/205

(57) ABSTRACT

The hydraulic motor drive device uses a radial hydraulic motor to drive a hydraulic pump for pumping pressure oil to form hydraulic energy and also uses the radial hydraulic motor to be configured as hydraulic energy for driving an executing element of a configuration load; a cylinder liner of the radial hydraulic motor is eccentrically and fixedly connected to the set circumference of a motor spindle of which the left end is supported by a tapered roller bearing fixedly connected in a motor left end cover of a left under-chassis and of which the right end is supported by a tapered roller bearing fixedly connected in a motor right end cover of a right under-chassis, so as to drive the motor spindle to rotate and operate; because hinge bars accept the transfer force by an engagement point and the force transferring direction is the direction of transferring the oil pressure configured according to the system need, namely that the direction from pushing a plunger in the cylinder liner by the oil pressure to pushing a roller by an outer hinge bar and the tangential component force direction of the force of a motor curved guide rail on the roller are consonant with the rotating and operating direction of the motor spindle, simultaneous working is achieved for driving the power system load; and the connection mode of the motor spindle of the radial hydraulic motor for driving the configuration equipment is internal connection, and can also be made into external connection of output shaft according to the configuration need.

### CROSS-REFERENCE TO RELATED APPLICATIONS

This application is a continuation in part of International Patent Application No. PCT/CN2013/076682 with an international filing date of Jun. 4, 2013 designating the United States, now pending. The content of the aforementioned application, including any intervening amendments thereto, is incorporated herein by reference.

### TECHNICAL FIELD

The present invention relates to a hydraulic motor drive device, which uses a hydraulic motor drive to replace a traditional power drive device for improving the effect of life environment while satisfying the drive power need of people in regions with insufficient resources.

### BACKGROUND OF THE PRESENT INVENTION

The existing power drive device generally uses electric energy and wind energy to perform drive or uses nuclear energy and fuel oil to perform power drive, but the resources in various places have great difference and people's requirements for environmental protection are increasingly enhanced, thereby prompting people to seek various power resources.

### SUMMARY OF THE PRESENT INVENTION

The technical solution of the hydraulic motor drive device of the present invention mainly comprises:

The hydraulic motor drive device uses a radial hydraulic motor to drive a hydraulic pump for pumping pressure oil to form hydraulic energy and also uses the radial hydraulic motor to be configured as hydraulic energy for driving an executing element of a configuration load; a cylinder liner of the radial hydraulic motor is eccentrically and fixedly connected to the set circumference of a motor spindle of which the left end is supported by a tapered roller bearing fixedly connected in a motor left end cover of a left under-chassis and of which the right end is supported by a tapered roller bearing fixedly connected in a motor right end cover of a right under-chassis, so as to drive the motor spindle to rotate and operate; because hinge bars accept the transfer force by an engagement point and the force transferring direction is the direction of transferring the oil pressure configured according to the system need, namely that the direction from pushing a plunger in the cylinder liner by the oil pressure to pushing a roller by an outer hinge bar and the tangential component force direction of the force of a motor curved guide rail on the roller are consistent with the rotating and operating direction of the motor spindle, simultaneous working is achieved for driving the power system load and the connection mode of the motor spindle of the radial hydraulic motor for driving the configuration equipment is internal connection, and can also be made into external connection of output shaft according to the configuration need.

### BRIEF DESCRIPTION OF THE DRAWINGS

FIG. (1) is a schematic diagram of one specific embodiment of a radial hydraulic motor in a hydraulic motor drive device of the present invention; Wherein:

1. motor curved guide rail 2. roller 3. outer hinge bar
4. roller mandrel 5. middle hinge bar 6. tapered roller bearing
7. motor connector end cover 6. motor port plate 9 motor spindle
10. right under-chassis 11. right positioning and guiding plate
12. motor nght end cover
13. guide bushing 14. plunger mandrel 15. inner hinge bar
16. plunger 17. left positioning and guiding plate 18. cylinder liner
19. motor left end cover 20. left under-chassis;

FIG. (2) is a schematic diagram of one specific embodiment where a hydraulic motor drive device of the present invention is applied to a power system load drive; Wherein: 1. hydraulically-operated hydraulic pump 2. oil path control block 3. hydraulic generator set 4. hydraulic integrated control block 5. hydraulic propeller 6. hydraulic propeller 7. displacement sensor 8. oil & gas energy-storage cylinder 9. one-way combination valve;

### DETAILED DESCRIPTION OF THE PRESENT INVENTION

In the embodiment, with reference to FIG. (1), the hydraulic motor drive device uses the radial hydraulic motor to drive the hydraulic pump for pumping pressure oil to form hydraulic energy and also uses the radial hydraulic motor to be configured as hydraulic energy for driving the executing element of the configuration load; the radial hydraulic motor comprises: pressure oil Fₚ enters a confined space formed by the bottom of the cylinder liner (18) eccentrically and fixedly connected to the set circumference of the motor spindle (9) and the bottom of the plunger (16) via the motor connector end cover (7) along an oil path of the port plate (8) and the motor spindle (9) of which the left end is supported by the tapered roller bearing (6) fixedly connected in the motor left end cover (19) of the left under-chassis (20) and of which the right end is supported by the tapered roller bearing (6) fixedly connected in the motor right end cover (12) of the right under-chassis (10); because the cylinder liner (18) is eccentrically and fixedly connected to the motor spindle (9) and an eccentric distance exists, oil pressure formed by the pressure oil Fₚ which acts on the bottom of the cylinder liner (18) points to the bottom of the cylinder liner (18) from the bottom of the plunger (16) for driving the motor spindle (9) to rotate and operate; due to the isotropy of the oil pressure, the oil pressure which acts on the bottom of the plunger (16) pushes the plunger (16) to operate along the inside of a line groove fixedly connected to a left positioning and guiding plate (17) and a right positioning and guiding plate (11) of the motor spindle (9) under the guidance of a plunger mandrel (14) of which both ends are placed in guide bushings (13) and positioned in the head of the plunger (16); the oil pressure pushes the plunger (16) to be transferred to an outer hinge bar (3) via an inner hinge bar (15) hinged in the plunger mandrel (14) and a middle hinge bar (5) engaged with the inner and the outer arcs of the inner hinge bar (15) in a manner of arc engagement; the middle hinge bar (5) is hinged in the middle of the outer hinge bar (3); one end of the outer hinge bar (3) is hinged on a positioning mandrel of the left positioning and guiding plate (17) and the right positioning and guiding plate (11), and the other end is hinged with both ends of a roller mandrel (4) in a roller (2) which is operated along the inner curve of a motor curved guide rail (1) inlaid in the middle of the motor left end cover (19) and the motor right end cover (12); because the hinge bars accept the transfer force by an engagement point and the force transferring direction is the direction of transferring the oil pressure configured according to the system need, namely that the direction from pushing the plunger (16) in the cylinder liner (18) by the oil pressure to pushing the roller (2) by the outer hinge bar (3) and the tangential component force direction of the force of the motor curved guide rail (1) on the roller (2) are consistent with the rotating and operating direction of the motor spindle (9), the action that the oil pressure which acts on the bottom of the plunger (16) pushes the roller (2) and the action that the oil pressure on the bottom of the cylinder liner (18) drives the motor spindle (9) operate in the same direction and simultaneously apply work; the number of interactions of the travel section and the return section of the motor curved guide rail (1) is configured according to the system need; when the plunger (16) returns, F₀ returns along the motor spindle (9), the port plate (8) and the oil path of the motor connector end cover (7) after cooled; and the connection mode of the motor spindle (9) of the radial hydraulic motor for driving the configuration equipment is internal connection, and can also be made into external connection of output shaft according to the configuration need.

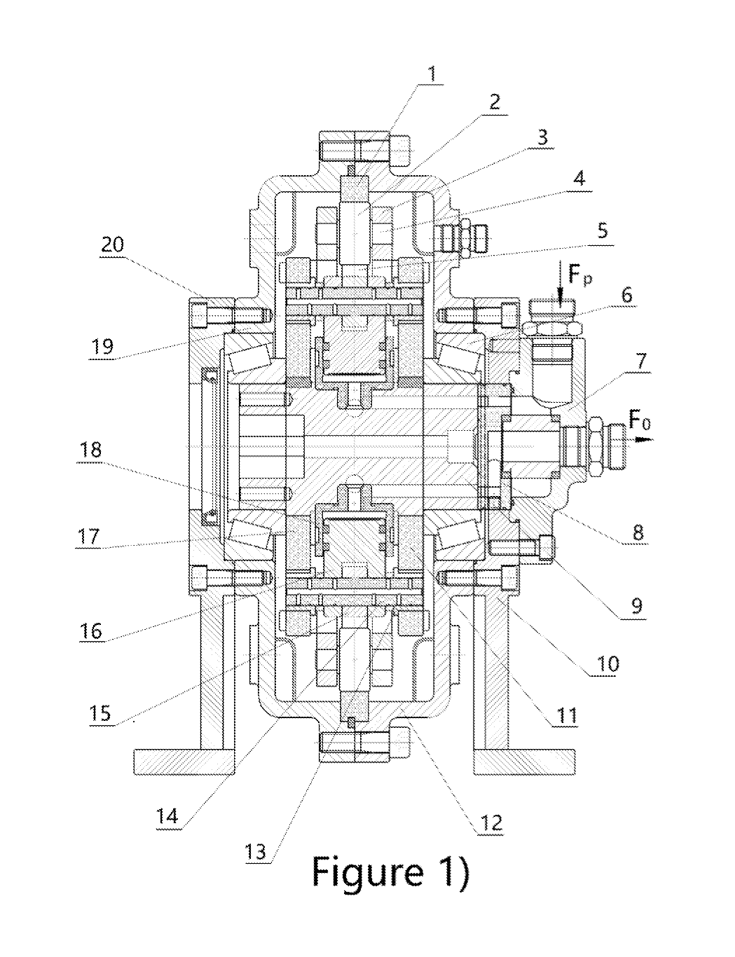

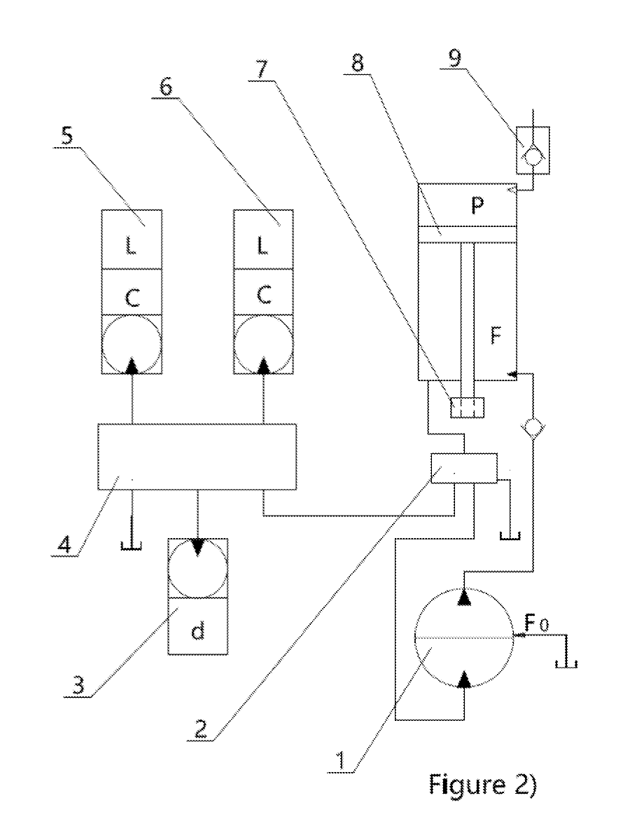

With reference to FIG. 2), when the hydraulic motor drive device is applied to the power system load drive, the hydraulic motor drive device uses a radial hydraulic motor to drive a hydraulic pump to achieve set hydraulic energy and also uses the radial hydraulic motor to be configured as hydraulic energy for driving an executing element of configuration equipment; a gas pressure cavity P of an oil & gas energy-storage cylinder (8) is filled with the configured external pressure gas through a one-way combination valve (9) so that the oil pressure cavity of the oil & gas energy-storage cylinder (8) has the oil pressure F; the radial plunger hydraulic motor for driving a hydraulically-operated hydraulic pump (1) in system configuration has adequate driving power; the oil pressure F controls the hydraulically-operated hydraulic pump (1) through an oil path control block (2) to pump pressure oil to be injected into an oil pressure cavity of the oil & gas energy-storage cylinder (8) for compressing the upper gas pressure cavity space, so that a displacement sensor (7) detects in real time and feeds back to the oil path control block (2) for real-time adjustment and control so that the oil pressure F and the gas pressure P are increased to system set values and kept in the scope of the system configuration need; the oil pressure F is adjusted and controlled by a hydraulic integrated control block (4) via the oil path control block (2), and a hydraulic generator set (3) is driven according to the system configuration to operate and generate electricity to satisfy the electricity configuration need of the system; the oil pressure F is adjusted and controlled by a hydraulic integrated control block (4) via the oil path control block (2), and a hydraulic propeller (5) and a hydraulic propeller (6) are driven to operate according to the system configuration to satisfy the load drive configuration need of a power system; in the embodiment, C represents a gear box for adjusting and controlling the operation direction, and L represents that the drive load is the propeller: in the application as a machine tool power system, L represents that the drive load can be a machine tool spindle; in the application as a vehicle power system, L represents that the drive load is a vehicle driving mechanism; the thrust and the speed when the hydraulic motor drive device is applied to the power system load drive can be adjusted and controlled according to the system configuration; and the example application of combination and integration of system configurations can realize multiple transformations to adapt to various system configuration needs of power equipment.

I claim:

1. A hydraulic motor drive device, characterized in that: the hydraulic motor drive device uses a radial hydraulic motor to drive a hydraulic pump for pumping pressure oil to form hydraulic energy and also uses the radial hydraulic motor to be configured as hydraulic energy for driving an executing element of a configuration load, and configures hinge bars for a plunger (16) of the radial hydraulic motor to perform the transformation of transfer force of an engagement point of the hinge bars; the hinge bars accept the transfer force by the engagement point and the force transferring direction is the direction of transferring the oil pressure configured according to the system need, namely that the direction from pushing the plunger (16) in the cylinder liner (18) by the oil pressure to pushing the roller (2) by the outer hinge bar (3) and the tangential component force direction of the force of the motor curved guide rail (1) on the roller (2) are consistent with the rotating and operating direction of the motor spindle (9).

2. The hydraulic motor drive device of claim 1, characterized in that; the pressure oil F of the radial hydraulic motor enters a confined space formed by the bottom of a cylinder liner (18) eccentrically and fixedly connected to the set circumference of a motor spindle (9) and the bottom of a plunger (16) via a motor connector end cover (7) along a port plate (8) and an oil path of the motor spindle (9) of which the left end is supported by a tapered roller bearing (6) fixedly connected in a motor left end cover (19) of a left under-chassis (20) and of which the right end is supported by a tapered roller bearing (6) fixedly connected in a motor right end cover (12) of a right under-chassis (10); because the cylinder liner (18) is eccentrically and fixedly connected to the motor spindle (9) and an eccentric distance exists, oil pressure formed by the pressure oil Fₚ which acts on the bottom of the cylinder liner (18) points to the bottom of the cylinder liner (18) from the bottom of the plunger (16) for driving the motor spindle (9) to rotate and operate.

3. The hydraulic motor drive device of claim 1, characterized in that: due to the isotropy of the oil pressure, the oil pressure which acts on the bottom of the plunger (16) pushes the plunger (16) to operate along the inside of a line groove fixedly connected to a left positioning and guiding plate (17) and a right positioning and guiding plate (11) of the motor spindle (9) under the guidance of a plunger mandrel (14) of which both ends are placed in guide bushings (13) and positioned in the head of the plunger (16); the oil pressure pushes the plunger (16) to be transferred to an outer hinge bar (3) via an inner hinge bar (15) hinged in the plunger mandrel (14) and a middle hinge bar (5) engaged with the inner and the outer arcs of the inner hinge bar (15) in a manner of arc engagement; the middle hinge bar (5) is hinged in the middle of the outer hinge bar (3); and one end of the outer hinge bar (3) is hinged on a positioning mandrel of the left positioning and guiding plate (17) and the right positioning and guiding plate (11), and the other end is hinged with both ends of a roller mandrel (4) in a roller (2) which is operated along the inner curve of a motor curved guide rail (1) inlaid in the middle of the motor left end cover (19) and the motor right end cover (12).

4. The hydraulic motor drive device of claim 1, characterized in that: the pressure oil Fₚ enters a confined space formed by the bottom of the cylinder liner (18) and the bottom of the plunger (16) to form the oil pressure; and the action that the oil pressure which acts on the bottom of the plunger (16) pushes the roller (2) and the action that the oil pressure on the bottom of the cylinder liner (18) drives the motor spindle (9) operate in the same direction and simultaneously apply work.

5. The hydraulic motor drive device of claim 1, characterized in that: the number of interactions of the travel section and the return section of the motor curved guide rail (1) is configured according to the system need.

6. A power system load drive, characterized by comprising the hydraulic motor drive device of claim 1; the hydraulic motor drive device is applied to the power system load drive means that the hydraulic motor drive device uses the radial hydraulic motor to drive the hydraulic pump for pumping pressure oil to form hydraulic energy and also uses the radial hydraulic motor to be configured as hydraulic energy for driving the executing element of the configuration load; a gas pressure cavity P of an oil & gas energy-storage cylinder (8) is filled with the configured external pressure gas through a one-way combination valve (9) so that the oil pressure cavity of the oil & gas energy-storage cylinder (8) has the oil pressure F; the radial plunger hydraulic motor for driving a hydraulically-operated hydraulic pump (1) in system configuration has adequate driving power: the oil pressure F controls the hydraulically-operated hydraulic pump (1) through an oil path control block (2) to pump the pressure oil to be injected into an oil pressure cavity of the oil & gas energy-storage cylinder (8) for compressing the upper gas pressure cavity space, so that a displacement sensor (7) detects in real time and feeds back to the oil path control block (2) for real-time adjustment and control so that the oil pressure F and the gas pressure P are increased to system set values and kept in the scope of the system configuration need; and the oil pressure F is adjusted and controlled by a hydraulic integrated control block (4) via the oil path control block (2), and a hydraulic generator set (3) is driven according to the system configuration to operate and generate electricity to satisfy the electricity need of the system.

7. The power system load drive of claim 6, characterized in that: the oil pressure F is adjusted and controlled by a hydraulic integrated control block (4) via the oil path control block (2), and a hydraulic propeller (5) and a hydraulic propeller (6) are driven to operate according to the system configuration to satisfy the load drive configuration need of a power system; C represents a gear box for adjusting and controlling the operation direction, and L represents that the drive load is the propeller.

8. The power system load drive of claim 6, characterized in that: in the application as a machine tool power system, L represents that the drive load is a machine tool spindle; and in the application as a vehicle power system, L represents that the drive load is a vehicle driving mechanism.
